(19) United States
(12) Patent Application Publication
(10) Pub. No.: US 2023/0049024 A1
(43) Pub. Date: Feb. 16, 2023

(54) SYSTEM AND METHOD FOR VEHICLE BATTERY HEATING

(71) Applicant: GM GLOBAL TECHNOLOGY OPERATIONS LLC, Detroit, MI (US)

(72) Inventors: Aaron B. Bloom, Royal Oak, MI (US); Dave G. Rich, Sterling Heights, MI (US); Jingyuan Liu, Shanghai (CN); Dewen Kong, Shanghai (CN)

(73) Assignee: GM GLOBAL TECHNOLOGY OPERATIONS LLC, Detroit, MI (US)

(21) Appl. No.: 17/401,651

(22) Filed: Aug. 13, 2021

(51) Int. Cl. H01M 10/615; H01M 10/625; H01M 10/6571

(52) U.S. Cl. CPC H01M 10/615; H01M 10/625; H01M 10/6571; H01M 10/486; H01M 2220/20

(57) ABSTRACT

A system for vehicle battery heating is provided. The system includes a battery, including a plurality of battery cells. The system further includes a computerized battery controller operable to selectively energize a portion of the battery cells to provide an increased temperature of the portion of the battery cells. The portion of the battery cells may be energized in a distributed pattern or a focused pattern.

### INTRODUCTION

The disclosure generally relates to a system and method for vehicle battery heating.

### SUMMARY

A system for vehicle battery heating is provided. The system includes a battery, including a plurality of battery cells. The system further includes a computerized battery controller operable to selectively energize a portion of the battery cells to provide an increased temperature of the portion of the battery cells.

In one embodiment, the computerized battery controller is further operable to selectively energize the portion of the battery cells selected from the plurality of battery cells in a distributed pattern, such that the increased temperature of the portion of the battery cells provides distributed heat throughout the plurality of battery cells.

In one embodiment, the distributed pattern includes an alternating pattern, with neighboring pairs of the plurality of battery cells alternating between an energized state and a deenergized state.

In one embodiment, the computerized battery controller is further operable to selectively energize the portion of the battery cells selected from the plurality of battery cells in a focused pattern, such that the increased temperature of the portion of the battery cells heats the portion of the battery cells more rapidly than a remaining portion of the battery cells.

In one embodiment, the portion of the battery cells form a rectangular pattern.

In one embodiment, the portion of the battery cells form a contiguous pattern, with the battery cells within the contiguous pattern being energized.

In one embodiment, the computerized battery controller is further operable to monitor operation of the portion of the battery cells, accumulate an aging factor upon the portion of the battery cells based upon the operation, and select a subsequent portion of the battery cells based upon evenly aging the plurality of battery cells.

In one embodiment, the battery is an air-cooled battery.

In one embodiment, the computerized battery controller is operable to monitor a request to start-up the vehicle, the request including an indication whether a rapid start-up event is to be executed. When the request to start-up the vehicle does not include the indication that the rapid start-up event is to be executed, the computerized battery controller is operable to selectively energize the portion of the battery cells selected from the plurality of battery cells in a distributed pattern, such that the increased temperature of the portion of the battery cells provides distributed heat throughout the plurality of battery cells. When the request to start-up the vehicle does include the indication that the rapid start-up event is to be executed, the computerized battery controller is operable to selectively energize the portion of the battery cells selected from the plurality of battery cells in a focused pattern, such that the increased temperature of the portion of the battery cells heats the portion of the battery cells more rapidly than a remaining portion of the battery cells.

According to one alternative embodiment, a system for vehicle battery heating is provided. The system includes an air-cooled battery, including a plurality of battery cells and a computerized battery controller. The computerized battery controller is operable to monitor a request to start-up the vehicle, the request including an indication whether a rapid start-up event is to be executed. The computerized battery controller is further operable to selectively energize a portion of the battery cells to provide an increased temperature of the portion of the battery cells based upon the request. Selectively energizing the portion of the battery cells includes, when the request to start-up the vehicle does not include the indication that the rapid start-up event is to be executed, selectively energizing the portion of the battery cells selected from the plurality of battery cells in a distributed pattern, such that the increased temperature of the portion of the battery cells provides distributed heat throughout the plurality of battery cells. Selectively energizing the portion of the battery cells further includes, when the request to start-up the vehicle does include the indication that the rapid start-up event is to be executed, selectively energize the portion of the battery cells selected from the plurality of battery cells in a focused pattern, such that the increased temperature of the portion of the battery cells heats the portion of the battery cells more rapidly than a remaining portion of the battery cells.

In some embodiments, the distributed pattern includes an alternating pattern, with neighboring pairs of the plurality of battery cells alternating between an energized state and a deenergized state.

In some embodiments, the focused pattern includes a rectangular pattern.

In some embodiments, the focused pattern includes a contiguous pattern, with the battery cells within the contiguous pattern being energized.

In some embodiments, the focused pattern includes a string of the battery cells connected in series.

In some embodiments, the computerized battery controller is further operable to monitor operation of the portion of the battery cells, accumulate an aging factor upon the portion of the battery cells based upon the operation, and select a subsequent portion of the battery cells based upon evenly aging the plurality of battery cells.

According to one alternative embodiment, a method for vehicle battery heating is provided. The method includes, within a computerized battery controller, monitoring a temperature of a plurality of battery cells within a battery and selectively energizing a portion of the battery cells to provide an increased temperature of the portion of the battery cells based upon the temperature.

In some embodiments, the method further includes, within the computerized battery controller, monitoring a request to start-up the vehicle, the request including an indication whether a rapid start-up event is to be executed, and selectively energizing the portion of the battery cells further based upon the request. Selectively energizing the portion of the battery cells includes, when the request to start-up the vehicle does not include the indication that the rapid start-up event is to be executed, selectively energize the portion of the battery cells selected from the plurality of battery cells in a distributed pattern, such that the increased temperature of the portion of the battery cells provides distributed heat throughout the plurality of battery cells. Selectively energizing the portion of the battery cells further includes, when the request to start-up the vehicle does include the indication that the rapid start-up event is to be executed, selectively energize the portion of the battery cells selected from the plurality of battery cells in a focused pattern, such that the increased temperature of the portion of the battery cells heats the portion of the battery cells more rapidly than a remaining portion of the battery cells.

In some embodiments, the method further includes, within the computerized battery controller, monitoring operation of the portion of the battery cells, accumulating an aging factor upon the portion of the battery cells based upon the operation, and selecting a subsequent portion of the battery cells based upon evenly aging the plurality of battery cells.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates a system for vehicle battery heating, in accordance with the present disclosure;

FIG. 2 schematically illustrates an exemplary battery module including a plurality of battery cell strings, wherein the battery module is air cooled, in accordance with the present disclosure;

FIG. 3 schematically illustrates an alternative battery module including three battery cell strings, in accordance with the present disclosure;

FIG. 4 schematically illustrates an exemplary vehicle including a system for vehicle battery heating, in accordance with the present disclosure;

FIG. 5 schematically illustrates an exemplary a computerized battery controller, in accordance with the present disclosure; and

FIG. 6 is a flowchart illustrating a method for vehicle battery heating, in accordance with the present disclosure.

### DETAILED DESCRIPTION

A system and method for vehicle battery heating are provided. Efficient battery operation and reliable operation of a vehicle utilizing stored energy in one or more batteries are temperature dependent. A battery or a plurality of battery cells collectively providing electrical energy within a battery benefit from operation within a desired temperature range.

A battery may include a temperature regulation system. For example, a battery may be air-cooled or liquid-cooled. In a battery that is liquid-cooled, a circuit of fluid or coolant may be utilized within the battery to remove heat from the battery in a high-temperature condition, transferring heat from one or more battery cells to the coolant. When the battery is in a low-temperature condition, warm or heated coolant may instead be circulated through the circuit to heat the battery and quickly bring the battery up to a desired temperature range. In a battery that is air-cooled, a circuit may be utilized within the battery to remove heat from the battery in a high-temperature condition, transferring heat from one or more battery cells to a flow of air. If a warm or heated flow of air is available, such a flow of air may be utilized to heat a battery in a low-temperature condition. However, in many conditions, no such warm or heated flow of air is available to heat the battery.

Battery heating methods employed in air-cooled batteries may include relatively long heating or temperature preparation cycles. A battery heating function for air-cooled batteries may fail to warm up the battery in a permissible warm up time. According to one test parameter, a battery heating function may attempt to bring the battery cell temperature to above zero degrees centigrade in fifteen minutes or less. A battery cell at a temperature below the desired temperature range or design temperature range for the battery cell includes high electrical resistance as compared to the same battery cell operating with the desired temperature range. This high electrical resistance may make delivering full energy discharge of the battery cell inefficient or difficult. Similarly, quickly charging a cold battery cell may be inefficient, difficult, or cause plating issues within the battery cell.

Lithium-ion battery systems, in some examples, may include 12 Volt, 48 Volt, 12 Volt / 48 Volt, or other equivalent power systems with air-cooled batteries. Such relatively low voltage systems including air-cooled batteries may include unacceptably long temperature preparation cycles prior to being fully available to power a vehicle or provide energy for high energy discharge events. In one embodiment of a 12 Volt / 48 Volt power system which may be described as a MODACS (Multiple Output Dynamically Adjustable Capacity) battery system, groups of battery cells in strings may be treated as units within the battery system, and one or more of these strings may be selectively activated and used together in parallel or in series to deliver a desired electric Voltage and current to the vehicle or charge in a particular manner. The disclosed system and method may provide a number of benefits in a MODACS system, although the disclosed system and method may provide benefits similarly to other battery systems.

Batteries generate heat as they discharge or charge. Heat generated may be described by the following equation:

$$H = {I}^{2} R t$$

wherein, H is the heat generated, I is the current per unit time discharged by the battery cell, R is the resistance of the battery cell, and t is the time period of heat generation. Heat generated by the battery cell increases by the square of the current per unit time discharged from the battery cell. By providing energy discharge from a portion of available battery cells, heat generated by the discharge may be increased as compared to heat that would be generated by using the available battery cells.

A system and method for vehicle battery heating is provided by providing targeted discharge commands to selected battery cells within a vehicle battery. In a first scenario or first control mode, a control strategy may include equally heating battery cells at an optimal or selected rate when a rapid drive away event is not anticipated benefits vehicle battery operation. Such a control strategy may benefit operation of a electrically-powered vehicle, autonomous or semi-autonomous vehicle, and a battery system operated in conjunction with an internal combustion engine. The first control mode employs battery cells in an even manner. The disclosed system and method, operating the first control mode, operates the battery cells or cell modules in a similar “firing pattern” to a combustion engine alternating activation of cylinders, with equal amounts of discharge and charge time on each battery cell at a defined frequency.

In a second scenario or second control mode, enabling rapid and full use of the associated vehicle in as short of a time as possible, a control strategy may be defined utilizing modulation of battery cells and associated battery cell discharge in a targeted sequence and frequency to both reduce time to drive away and time for mission important drive away events in a vehicle utilizing a battery system. Full use of the vehicle benefitting from a rapid heating of a portion of the battery cells may include a desired rapid drive away event or use of high energy usage operations such as electrically heating a window. This second control mode may utilize super-cell heating or focused module heating, focusing raising a temperature of a select portion of the battery cells to get those cells up to a desired temperature range quickly rather than raising the temperature of the battery cells uniformly within the battery. The super-cell heating may maintain larger loads on fewer modules for longer to heat them more quickly to ensure a minimum energy and power capability to execute high-severity, degraded state maneuvers.

The second control mode including focused heating of a portion of the battery cells within a battery may, if repeatedly performed upon a same portion of the battery cells, disproportionately age the same portion of the battery cells as compared to a remainder of the battery cells. For example, high intracell and/or intercell temperature differences may drive battery cell aging. In one embodiment, the disclosed system and method may track which battery cells are utilized in the second control mode and may rotate or alternate which portion of the battery cells are utilized in the second control mode, with a goal of evenly utilizing the battery cells in the second control mode over multiple uses of the second control mode.

The disclosed system and method substantially decrease a time to warm up a portion of battery cells to execute degraded maneuvers in autonomous applications when rapid driveaway is requested.

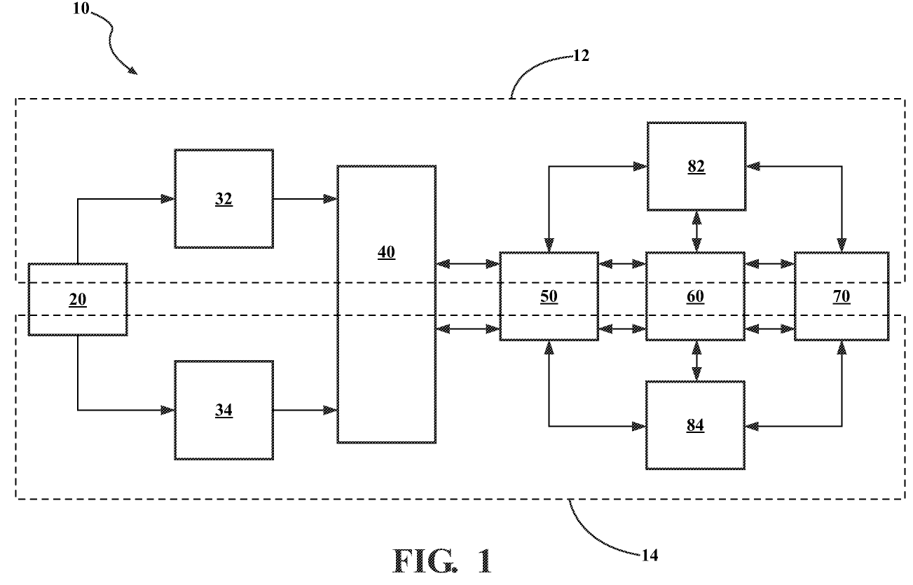

FIG. 1 schematically illustrates a system 10 for vehicle battery heating. The system 10 includes a redundant 12 Volt power system including a first grid 12 and a second grid 14, each grid being independently capable of providing adequate power to operate the vehicle. The system 10 includes HV (high voltage) battery 20, accessory power module (APM) 32, APM 34, fail operational power module (FOPM) 40, 12 Volt battery 82, and 12 Volt battery 84. The HV battery 20 may supply electric power in a 350-800 Volt range and may provide power primarily to a vehicle propulsion system. The 12 Volt battery 82 and the 12 Volt battery 84 may supply power to vehicle systems such as power windows and a climate control system. The 12 Volt battery 82 and the 12 Volt battery 84 may be used to provide boost propulsion power or, in some embodiments, power to the vehicle propulsions system. The HV battery 20 may provide charging power to the 12 Volt battery 82 and the 12 Volt battery 84, and vice versa. The APM 32 and the APM 34 may function as direct current to direct current converters, transforming electrical energy from one Voltage level to another Voltage level. The APM 32 and the APM 34 may be uni-directional or bi-directional. The FOPM 40 may include a switching and control system useful to coordinate operation of the first grid 12 and the second grid 14, for example, operating both grids interdependently when the systems are operational and operating one grid independently and isolating the other grid when a problem is detected.

The HV battery 20, the APM 32, the FOPM 40, and the 12 Volt battery 82 function as the first grid 12 providing power to each of a nominal load 50, an auxiliary load 60, and a transient load 70. The HV battery 20, the APM 34, the FOPM 40, and the 12 Volt battery 84 function as the second grid 14 providing power to each of the nominal load 50, the auxiliary load 60, and the transient load 70. The nominal load 50 may include operation of primary systems for the vehicle, such as a power steering pump and a transmission system. The auxiliary load 60 may include peripheral devices such as heated glass and a climate control system including heating and air conditioning of a vehicle passenger compartment. The transient load 70 includes time limited device usages or tasks, which may include brief but high-demand spikes in energy usage, such as propulsion boost supplied during rapid vehicle acceleration events or navigation up a steep incline.

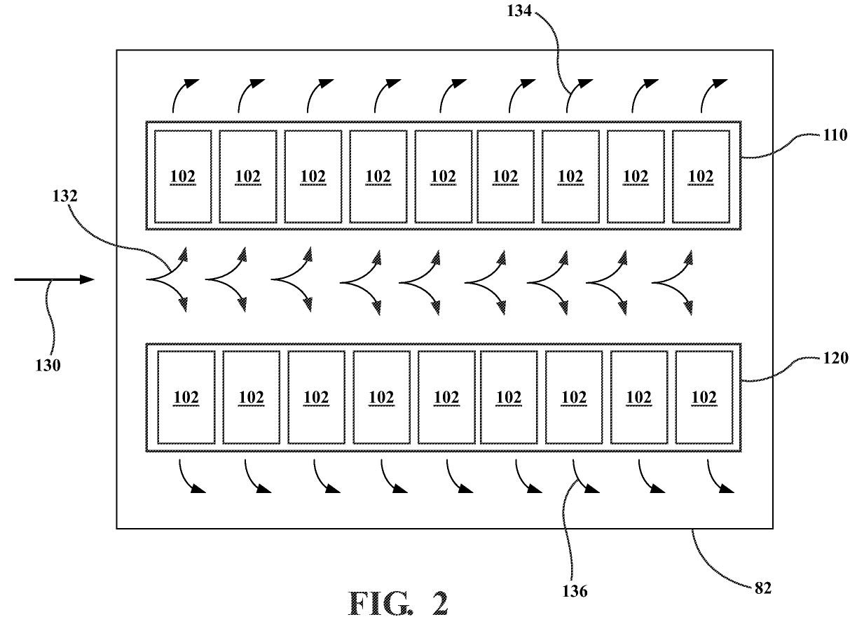

Each of the 12 Volt battery 82 and the 12 Volt battery 84 may include a plurality of battery cells. A battery cell may include a single unit including an anode, a cathode, a membrane, and an electrolyte, wherein the battery cell is capable of receiving electrical energy in a charging mode and is capable of providing electrical energy in a discharge mode. In one embodiment, a plurality of battery cells may be arranged in a string, with the battery including a plurality of strings. FIG. 2 schematically illustrates the 12 Volt battery 82 including a plurality of strings of battery cells 102, wherein the battery is air cooled. The 12 Volt battery 82 is illustrated including string 110 and string 120. The exemplary string 110 includes nine battery cells 102. The exemplary string 120 includes nine battery cells 102. A battery may include different number of strings. Each string may include different numbers of battery cells. In one embodiment, the string 110 and the string 120 operate as a block delivering some desired measure of electrical power, such as a supply of electric power at 12 Volts. Multiple strings may be applied together in series to provide a desired Voltage, for example, 48 Volts.

As each of the battery cells 102 operate either in charge mode or discharge mode, they generate heat. To avoid over-temperature conditions, this heat may be transferred away from the battery cells 102. The 12 Volt battery 82 is an air-cooled battery. An intake flow 130 of air is illustrated separated into a distributed flow path 132 which flows through channels next to each of the battery cells 102. After flowing past each of the battery cells 102, the air forms a first exiting flow path 134 and a second exiting flow path 136, each including heated air exiting the 12 Volt battery 82.

The battery cells 102 may be individually energized or deenergized according to desired operation of the 12 Volt battery 82. In some instances, battery cells 102 may be connected in parallel or in series. In some instances, some portion of the battery cells 102 may be utilized to charge another portion of the battery cells 102.

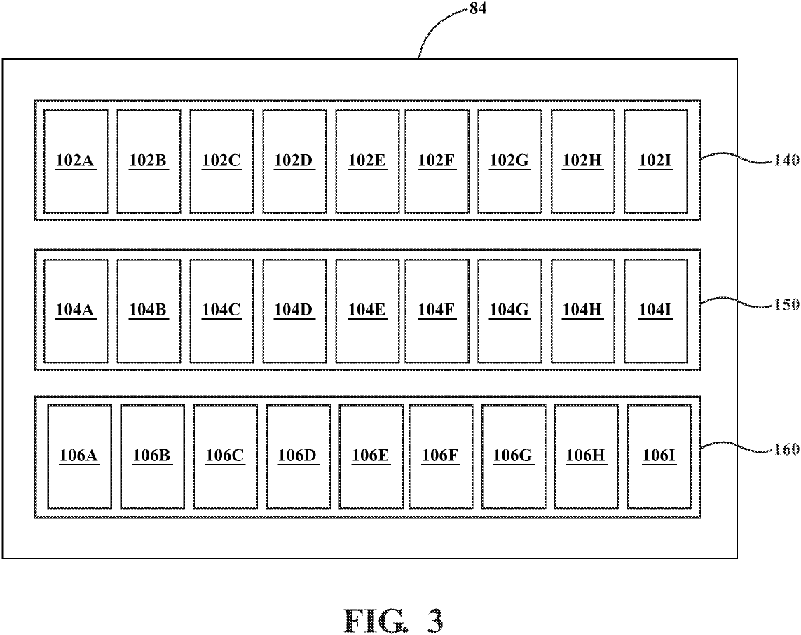

FIG. 3 schematically illustrates 12 Volt battery 84 including three battery cell strings. The 12 Volt battery 84 is illustrated including string 140, string 150, and string 160. The string 140 includes battery cell 102A, battery cell 102B, battery cell 102C, battery cell 102D, battery cell 102E, battery cell 102F, battery cell 102G, battery cell 102H, and battery cell 102I. The string 150 includes battery cell 104A, battery cell 104B, battery cell 104C, battery cell 104D, battery cell 104E, battery cell 104F, battery cell 104G, battery cell 104H, and battery cell 104I. The string 160 includes battery cell 106A, battery cell 106B, battery cell 106C, battery cell 106D, battery cell 106E, battery cell 106F, battery cell 106G, battery cell 106H, and battery cell 106I. A battery may include different number of strings. Each string may include different numbers of battery cells.

As each battery cell of the 12 Volt battery 84 operates in either charging mode or discharging mode, for example, battery cell 104C, the battery cell 104C creates heat. That heat may increase the temperature of the battery cell 104C itself. That heat may additionally transfer to nearby battery cells, including the battery cell 102C, the battery cell 104B, the battery cell 104D, and the battery cell 106C. By selectively energizing a portion of the battery cells, a desired heating pattern across the battery cells may be achieved. As described in relation to Equation 1, by utilizing/energizing a selected portion of the battery cells and keeping a remaining portion inactive/deenergized, current within the selected portion of the battery cells may be increased, which increases the heat generated by a square factor. In one example, a single one of the battery cells of the 12 Volt battery 84 may be energized at a time, thereby significantly increasing a current within the one of the battery cells, and that selected, energized one of the battery cells may be rotated through the 12 Volt battery 84, intensely heating one of the battery cells at a time. In a less intense example, four of the battery cells may be energized at a time, with the selected, energized four of the battery cells rotating through the 12 Volt battery 84. In one embodiment, one string of cells may be energized at a time, with other strings being retained as deenergized. In another embodiment, one module including a plurality of strings may be energized at a time, with other modules being retained as deenergized.

In the first control mode described herein, a distributed pattern, evenly distributed pattern, or alternating pattern of energized and deenergized battery cells may be employed to heat a portion of battery cells within the 12 Volt battery 84 more quickly than would energizing the battery cells uniformly. In one example, the battery cell 102A, the battery cell 102C, the battery cell 102E, the battery cell 102G, the battery cell 102I, the battery cell 104B, the battery cell 104D, the battery cell 104F, the battery cell 104H, the battery cell 106A, the battery cell 106C, the battery cell 106E, the battery cell 106G, and the battery cell 106I may be defined as a selected, energized portion of the battery cells of the 12 Volt battery 84. The battery cell 102B, the battery cell 102D, the battery cell 102F, the battery cell 102H, the battery cell 104A, the battery cell 104C, the battery cell 104E, the battery cell 104G, the battery cell 104I, the battery cell 106B, the battery cell 106D, the battery cell 106F, and the battery cell 106H may be defined as a remaining, deenergized portion of the battery cells of the 12 Volt battery 84. By utilizing this alternating pattern of energized and deenergized battery cells, with neighboring pairs of the plurality of battery cells alternating between the energized and deenergized states, the 12 Volt battery 84 may be heated more quickly than if each battery cell of the 12 Volt battery 84 were simultaneously energized. A number of alternating or distributed energizing patterns in accordance with the first control mode are envisioned, for example, with every third battery cell being energized or with every third battery cell being deenergized, and the disclosure is not intended to be limited to the examples provided herein.

In the second control mode described herein, a selected portion of the battery cells of the 12 Volt battery 84 may be energized in a pattern selected to heat a portion of the 12 Volt battery 84 as rapidly as possible. In one example, a block of nine adjacent battery cells in a square or rectangular pattern may define a selected, energized portion of the battery cells. These energized cells may form a contiguous portion of the battery cells, with the battery cells within the pattern being energized. For example, the battery cell 102D, the battery cell 102E, the battery cell 102F, the battery cell 104D, the battery cell 104E, the battery cell 104F, the battery cell 106D, the battery cell 106E, and the battery cell 106F may be defined as a selected, energized portion of the battery cells of the 12 Volt battery 84. As compared with an alternating pattern of energized and deenergized battery cells, this block of adjacent battery cells defined as the selected, energized portion of the battery cells utilizes fewer battery cells and therefore provides a greater total amount of heat for a given energy load, and, further, because the energized battery cells are next to each other, heat transferred from each of the energized battery cells to neighboring energized battery cells will intensify heat within the energized battery cells and create a high-temperature zone within the 12 Volt battery 84. In this way, a portion of the 12 Volt battery 84 may rapidly be increased into a desired temperature range and enable full operation of the battery cells within that portion of the 12 Volt battery 84 to provide desired operation of the vehicle rapidly.

In another example, the string 150 may be energized, and the string 140 and the string 160 may be deenergized. In another example, a module or group of strings represented as the 12 Volt battery 84 may energized, with a second module represented as the 12 Volt battery 82 of FIG. 1 being deenergized. A number of different heating patterns in accordance with the second control mode are envisioned, for example, with a triangular or diamond shaped pattern being energized or with neighboring strings being energized, and the disclosure is not intended to be limited to the examples provided herein.

The 12 Volt battery 82 and the 12 Volt battery 84 are illustrated including different battery cell configurations there within. These configurations are exemplary, the 12 Volt battery 82 and the 12 Volt battery 84 may be similar or distinct from each other, and the disclosure is not intended to be limited to the configurations illustrated.

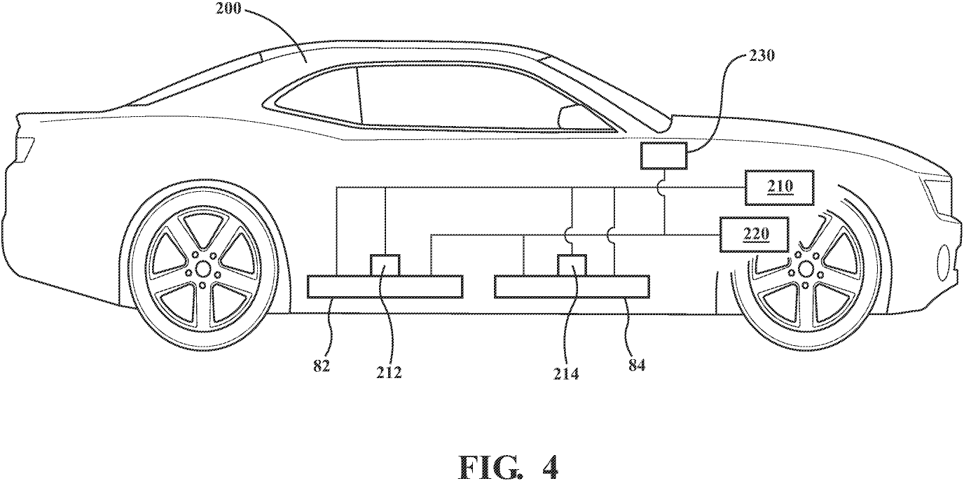

FIG. 4 schematically illustrates an exemplary vehicle 200 including a system for vehicle battery heating. The vehicle 200 is illustrated including the first 12 Volt battery 82, the second 12 Volt battery 84, a computerized battery controller 210, a vehicle propulsion system 220, and an auxiliary device 230. The 12 Volt battery 82 and the 12 Volt battery 84 are electrically connected to the vehicle propulsion system 220 and provide electrical energy to generate motive force for the vehicle. The 12 Volt battery 82 and the 12 Volt battery 84 are electrically connected to the auxiliary device 230 and provide electrical energy to the auxiliary device 230. The auxiliary device may include a heated window unit, a power steering pump, a vehicle headlight, a power window unit, or another similar vehicle device or system. At least one temperature sensor 212 is illustrated monitoring the 12 Volt battery 82, and at least one temperature sensor 214 is illustrated monitoring the 12 Volt battery 84. In one embodiment, the battery cells within the 12 Volt battery 82 and the 12 Volt battery 84 each have a temperature sensor. The temperature sensor 212 and the temperature sensor 214 are in electronic communication with the computerized battery controller 210 and may provide temperature data to the computerized battery controller 210. The computerized battery controller 210 is in electronic communication with the 12 Volt battery 82 and the 12 Volt battery 84, and is operable to selectively energize or deenergize, either in charging mode or discharging mode, each of the battery cells of the 12 Volt battery 82 and the 12 Volt battery 84. The vehicle 200 may include an electronic bus device useful to enable electronic communication between various components of the vehicle 200.

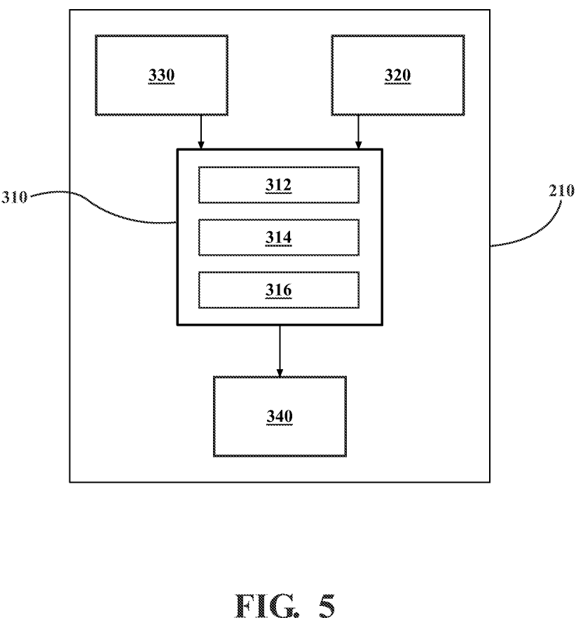

FIG. 5 schematically illustrates an exemplary computerized battery controller 210. Computerized battery controller 210 includes processing device 310, communications device 320, data input output device 330, and memory storage device 340. It is noted that computerized battery controller 210 may include other components and some of the components are not present in some embodiments.

The processing device 310 may include memory, e.g., read only memory (ROM) and random-access memory (RAM), storing processor-executable instructions and one or more processors that execute the processor-executable instructions. In embodiments where the processing device 310 includes two or more processors, the processors may operate in a parallel or distributed manner. Processing device 310 may execute the operating system of the computerized battery controller 210. Processing device 310 may include one or more modules executing programmed code or computerized processes or methods including executable steps. Illustrated modules may include a single physical device or functionality spanning multiple physical devices. In the illustrative embodiment, the processing device 310 also includes a battery cell temperature module 312, a heat mode selection and activation module 314, and a battery cell aging mitigation module 316, which are described in greater detail below.

The data input output device 330 is a device that is operable to take data gathered from sensors and devices throughout the vehicle and process the data into formats readily usable by processing device 310. Data input output device 330 is further operable to process output from processing device 310 and enable use of that output by other devices or control modules throughout the vehicle.

The communications device 320 may include a communications / data connection with a bus device configured to transfer data to different components of the system and may include one or more wireless transceivers for performing wireless communication.

The memory storage device 340 is a device that stores data generated or received by the computerized battery controller 210. The memory storage device 340 may include, but is not limited to, a hard disc drive, an optical disc drive, and/or a flash memory drive.

The battery cell temperature module 312 may collect data from batteries, strings within a battery, and/or individual battery cells. The battery cell temperature module 312 may include programming to estimate an amount of heating useful to bring one or more batteries and/or one or more portions of battery cells up from a current temperature to a desired temperature range. The battery cell temperature module 312 may include an inter- and intra-cell temperature model useful to determine the optimal heating rates and duty cycles.

The heat mode selection and activation module 314 may include programming to receive data from devices within or around the vehicle to determine a desired heating mode for the batteries of the vehicle. A navigational touch-screen display within the vehicle may enable a user to program a desired start-up sequence for the vehicle. In the alternative, a portable cellular device of a user may include a computerized application enabling the user to program a desired start-up sequence, for example, at a particular time on selected days of the week or if a battery temperature or ambient temperature is below a threshold value at a particular time. Based upon a desired start-up mode, the heat mode selection and activation module 314 may initiate a first control mode including a distributed energizing pattern within one or more batteries or a second control mode including a focused, block pattern within one or more batteries.

The battery cell aging mitigation module 316 may track and record selective energizing of the various battery cells within batteries of the vehicle. The battery cell aging mitigation module 316 may control which battery cells within the vehicle are selectively energized in subsequent start-up events. By rotating or alternating which battery cells are utilized in start-up events, aging effects upon the battery cells may be distributed and minimized

Computerized battery controller 210 is provided as an exemplary computerized device capable of executing programmed code to accomplish the methods and processes described herein. A number of different embodiments of computerized battery controller 210, devices attached thereto, and modules operable therein are envisioned, and the disclosure is not intended to be limited to examples provided herein.

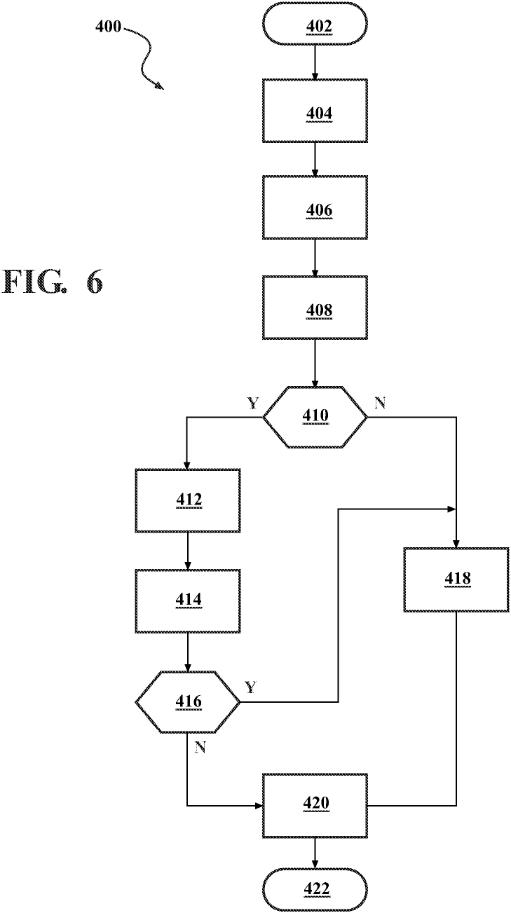

FIG. 6 is a flowchart illustrating a method 400 for vehicle battery heating. The method 400 starts at step 402. At step 404, a temperature of battery cells in one or more batteries of the vehicle are monitored. At step 406, a request to start the vehicle is monitored. The request may include additional information including an indication whether a normal or express start-up event is requested. At step 408, a determination is made based upon the temperature of the battery cells whether a start-up procedure according to the first control mode, including a distributed heating of the battery cells, or according to the second control mode, including a focused heating of a portion of the battery cells, is to be operated. At step 410, if the second control mode is selected in step 408, the method advances to step 412. If the second control mode is not selected in step 408, the method advances to step 418. At step 412, a portion of the battery cells for focused heating is selected and the focused heating of the portion of the battery cells is commanded. At step 414, focused heating of the portion of the battery cells is monitored and utilized to accumulate an aging factor for the battery cells which may be utilized to select a subsequent portion of the battery cells for focused heating in a later start-up event. At step 416, a determination is made whether subsequent distributed heating of a remainder of the battery cells is to be commanded. If distributed heating of the remainder of the battery cells is to be commanded, the method advances to step 418. If distributed heating of the remainder of the battery cells is not to be commanded, the method advances to step 420. At step 418, distributed heating of the battery cells is performed according to the first control mode, for example, with alternating battery cells being activated and deactivated, with the status of activation optionally switching one or more times during the start-up procedure. At step 420, the battery cell achieve a desired temperature range, for example, by reaching a minimum desired battery cell temperature, and battery cells may be energized or deenergized according to alternative control methods, such as managing state of charge and delivering desired energy to vehicle systems. At step 422, the method 400 ends. The method 400 is provided as an exemplary method for vehicle battery heating. Additional or alternative steps are envisioned, and the disclosure is not intended to be limited to the examples provided.

While the best modes for carrying out the disclosure have been described in detail, those familiar with the art to which this disclosure relates will recognize various alternative designs and embodiments for practicing the disclosure within the scope of the appended claims.

What is claimed is:

1. A system for vehicle battery heating, comprising:
a battery, including a plurality of battery cells; and
a computerized battery controller operable to selectively energize a portion of the battery cells to provide an increased temperature of the portion of the battery cells.

2. The system of claim 1, wherein the computerized battery controller is further operable to selectively energize the portion of the battery cells selected from the plurality of battery cells in a distributed pattern, such that the increased temperature of the portion of the battery cells provides distributed heat throughout the plurality of battery cells.

3. The system of claim 2, wherein the distributed pattern includes an alternating pattern, with neighboring pairs of the plurality of battery cells alternating between an energized state and a deenergized state.

4. The system of claim 1, wherein the computerized battery controller is further operable to selectively energize the portion of the battery cells selected from the plurality of battery cells in a focused pattern, such that the increased temperature of the portion of the battery cells heats the portion of the battery cells more rapidly than a remaining portion of the battery cells.

5. The system of claim 4, wherein the portion of the battery cells form a rectangular pattern.

6. The system of claim 4, wherein the portion of the battery cells form a contiguous pattern, with the battery cells within the contiguous pattern being energized.

7. The system of claim 4, wherein the computerized battery controller is further operable to:
monitor operation of the portion of the battery cells;
accumulate an aging factor upon the portion of the battery cells based upon the operation; and
select a subsequent portion of the battery cells based upon evenly aging the plurality of battery cells.

8. The system of claim 1, wherein the battery is an air-cooled battery.

9. The system of claim 1, wherein the computerized battery controller is operable to:
monitor a request to start-up a vehicle, the request including an indication whether a rapid start-up event is to be executed;
when the request to start-up the vehicle does not include the indication that the rapid start-up event is to be executed, selectively energize the portion of the battery cells selected from the plurality of battery cells in a distributed pattern, such that the increased temperature of the portion of the battery cells provides distributed heat throughout the plurality of battery cells; and
when the request to start-up the vehicle does include the indication that the rapid start-up event is to be executed, selectively energize the portion of the battery cells selected from the plurality of battery cells in a focused pattern, such that the increased temperature of the portion of the battery cells heats the portion of the battery cells more rapidly than a remaining portion of the battery cells.

10. A system for vehicle battery heating, comprising:
an air-cooled battery, including a plurality of battery cells; and
a computerized battery controller operable to:
monitor a request to start-up a vehicle, the request including an indication whether a rapid start-up event is to be executed;
selectively energize a portion of the battery cells to provide an increased temperature of the portion of the battery cells based upon the request, including:
when the request to start-up the vehicle does not include the indication that the rapid start-up event is to be executed, selectively energize the portion of the battery cells selected from the plurality of battery cells in a distributed pattern, such that the increased temperature of the portion of the battery cells provides distributed heat throughout the plurality of battery cells; and
when the request to start-up the vehicle does include the indication that the rapid start-up event is to be executed, selectively energize the portion of the battery cells selected from the plurality of battery cells in a focused pattern, such that the increased temperature of the portion of the battery cells heats the portion of the battery cells more rapidly than a remaining portion of the battery cells.

11. The system of claim 10, wherein the distributed pattern includes an alternating pattern, with neighboring pairs of the plurality of battery cells alternating between an energized state and a deenergized state.

12. The system of claim 10, wherein the focused pattern includes a rectangular pattern.

13. The system of claim 10, wherein the focused pattern includes a contiguous pattern, with the battery cells within the contiguous pattern being energized.

14. The system of claim 10, wherein the focused pattern includes a string of the battery cells connected in series.

15. The system of claim 10, wherein the computerized battery controller is further operable to:
monitor operation of the portion of the battery cells;
accumulate an aging factor upon the portion of the battery cells based upon the operation; and
select a subsequent portion of the battery cells based upon evenly aging the plurality of battery cells.

16. A method for vehicle battery heating, comprising:
within a computerized battery controller:
monitoring a temperature of a plurality of battery cells within a battery; and
selectively energizing a portion of the battery cells to provide an increased temperature of the portion of the battery cells based upon the temperature.

17. The method of claim 16, further comprising, within the computerized battery controller:
monitoring a request to start-up a vehicle, the request including an indication whether a rapid start-up event is to be executed; and
selectively energizing the portion of the battery cells further based upon the request, including:
when the request to start-up the vehicle does not include the indication that the rapid start-up event is to be executed, selectively energize the portion of the battery cells selected from the plurality of battery cells in a distributed pattern, such that the increased temperature of the portion of the battery cells provides distributed heat throughout the plurality of battery cells; and
when the request to start-up the vehicle does include the indication that the rapid start-up event is to be executed, selectively energize the portion of the battery cells selected from the plurality of battery cells in a focused pattern, such that the increased temperature of the portion of the battery cells heats the portion of the battery cells more rapidly than a remaining portion of the battery cells.

18. The method of claim 17, further comprising, within the computerized battery controller:
monitoring operation of the portion of the battery cells;
accumulating an aging factor upon the portion of the battery cells based upon the operation; and
selecting a subsequent portion of the battery cells based upon evenly aging the plurality of battery cells.
